(19) United States
(12) Patent Application Publication
(10) Pub. No.: US 2013/0186503 A1
(43) Pub. Date: Jul. 25, 2013

(54) Corrosion mitigation system and method

(71) Applicant: Raymond Royer, Crosby, TX (US)

(72) Inventor: Raymond Royer, Crosby, TX (US)

(21) Appl. No.: 13/374,917

(22) Filed: Jan. 23, 2012

(51) Int. Cl. F16L 9/14; B23P 11/00

(52) U.S. Cl. 138/140; 29/428

(57) ABSTRACT

A corrosion mitigation system for use in a pressurized pipeline for carrying pressurized fluids utilizes a plurality of metal pipes to form a pressurized pipeline wherein each pipe comprises connectors on opposite ends. The connectors comprise metallic connector components. Insulative material components which mate to said metallic connector components at said connections between said plurality of metal pipes for insulating the connectors and which conforms to respective ends of said plurality of metal pipes while permitting sufficient connection force at said connections to prevent leakage of said pressurized fluids.

### BACKGROUND OF THE INVENTION

1. Field of the Invention

The present invention relates generally to the field of electrolysis prevention in pipelines, and more specifically to the prevention of galvanic corrosion in interconnected pipelines.

2. Description of the Background

Electrolysis results in corrosion which is well known to damage interconnected pipes. The National Association of Corrosion Engineers estimates the cost of corrosion and corrosion protection to be in excess of $10 billion dollars per year. Blowouts of pressurized pipes continue to occur despite long term efforts to reduce and/or prevent corrosion due to electrolysis. In an effort to prevent the corrosion, different strategies have been employed in the past by those with skill in the art including employing coatings, chemical inhibitors, and cathodic protection. Another method is to coat anodic and cathodic metals with an epoxy or paint, or at minimum coating the anodic metal. This too can be problematic, because if the coated areas sustain damage, then the galvanic corrosion will occur nonetheless.

Various efforts to prevent electrolysis and/or corrosion is shown by the following background U.S. patents:

U.S. Pat. No. 6,080,293, issued Jun. 27, 2000, to T. Takeuchi et al., discloses an electrolytic test machine used for a corrosion resistance test for a test material comprised of a metal blank and a coating film. The electrolytic test machine is constructed so that an adverse influence, due to chlorine gas generated during a test, can be inhibited. The electrolytic test machine includes an electrolytic cell in which an aqueous solution of NaCl is stored so that a test material is immersed in the aqueous solution of NaCl. An electrode is immersed in the aqueous solution of NaCl. A DC power source supplies electric current between the electrode and the test material. A chlorine gas treating device collects chlorine gas which is generated with electrolysis of the aqueous solution of NaCl and which is released out of the aqueous solution of NaCl along with the aqueous solution of NaCl. The chlorine gas treating device includes a treating pipe line, a suction pump mounted on the treating pipe line, and a chlorine gas purifying member.

U.S. Pat. No. 4,037,810, issued Jul. 26, 1977, to H. Pate, discloses an improved pipe bracket and clamp for holding a pipe or conduit in a manner minimizing heat and sound transmission, preventing electrolysis or galvanic action and avoiding pipe rupture through thermal expansion and contraction. The clamp is preferably formed of a resilient synthetic resinous material in a unitary structure comprising a U-shaped body portion having a recess therein in which a toothed jaw portion is formed to receive and engage a pipe or conduit. A clamping portion is hingedly secured to the body portion by an integral flexible hinge and is adapted to fold about the hinge to enclose and engage the pipe or conduit in the recess by means of a corresponding toothed jaw portion formed on the clamping portion. A flange portion on the body portion includes an aperture which comes into alignment with a corresponding aperture in the clamping portion through which apertures a fastener may be received to clamp the pipe or conduit and secure it to a wall structure or the like. An alternate embodiment includes an integral cover structure for protecting the fastener from the adverse effects of corrosive or deleterious elements after the bracket is secured to the pipe or conduit.

U.S. Pat. No. 4,516,069, issued May 7, 1985, to D. Schmanski, discloses an electrolysis test station terminal support for use in connection with measurement of electrical properties of an underground pipe. The terminal support includes an elongated web structure formed of nonconductive plastic material and including at least one longitudinal rib integrally formed as part of the web structure. A hollow core is formed within the longitudinal rib and provides a housing for conductive wire to be concealed therein. An opening in the longitudinal rib provides access to the core to enable physical contact for measurement of electrical properties as conducted from the underground pipe through the wire into the terminal support.

U.S. Pat. No. 5,194,132, issued Mar. 16, 1993, to M. Hartmann, discloses an electrolysis apparatus for the production of chlorine, sodium hydroxide solution and hydrogen from aqueous alkali-metal halide solutions, which electrolysis apparatus comprises at least one electrolysis cell, anode and cathode, which are separated from one another by a partition, are disposed in a housing composed of two half-shells electrically separated by an insulating seal. The housing is provided with devices for supplying the electrolysis starting substances and for removing the electrolysis products, the latter comprising at least one discharge pipe which extends in the vertical direction in the interior of the half-shells, passes through the half-shell in the vicinity of the lower edge and extends up to the upper edge. The discharge pipe terminates in a separating chamber which is disposed in a stilling zone. The stilling zone is formed by a plate attached to the electrode and to the associated half-shell.

U.S. Pat. No. 6,276,726, issued Aug. 21, 2001, to R. Daspit, discloses a pipeline repair clamp partially or completely embracing the outer wall circumference of a pipe having a damaged area; a single or complementary semi-cylindrical clamp bodies having diametral engagement, the bodies having a semi-cylindrical bore contiguous to the pipe wall and with continuous seal grooves at its ends and sides, there being a metallic liner or dielectric coating said bore and terminating at the bottom of said grooves, a continuous gasket-compression seal carried in said grooves adapted to embrace said damaged area and seal with the pipe wall and at said liner-coating termination precluding electrolysis, and means forcefully drawing the clamp bodies onto the pipe wall.

The above discussed background efforts have not been found to solve the long-felt problems associated with corrosion and do not disclose the present invention. Accordingly, those of skill in the art will appreciate the present invention, which addresses the above and/or other problems.

### BRIEF DESCRIPTION OF THE DRAWINGS

FIG. 1A is an elevational view, partially in hidden lines, of pressurized metal pipeline flange connectors positioned adjacent each other prior to interconnection in accord with with one possible embodiment of the invention;

FIG. 1B is an elevational view of a Teflon gasket with a support member or plate inserted therein, which may be utilized in one possible embodiment of the present invention;

FIG. 1C is a front elevational view of a metal flange with circularly oriented apertures, which may be utilized in one possible embodiment of the present invention;

FIG. 1D is an insulated metal flange bolt which may be utilized in one possible embodiment of the present invention;

FIG. 2 is an enlarged elevational view, in cross section, of flange components for pressurized pipe which may be utilized in one possible embodiment of the present invention;

FIG. 3 is an elevational view, partially in cross section, of a pressurized pipe flange connection which may be utilized in one possible embodiment of the present invention;

FIG. 4 is an elevational view, partially in cross section, showing multiple sections of pressurized pipe, which are electrically insulated with respect to each other, which may be utilized in one possible embodiment of the present invention; and

FIG. 5 is an elevational view, in cross-section, showing an insulated threaded pressurized pipe connection in accord with one possible embodiment of the present invention.

### DESCRIPTION OF EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. It is to be further understood that the drawings are not necessarily intended to be in scale or provide manufacturing level drawings but rather may be exaggerated and/or altered to more clearly show representative features of various embodiments of the invention.

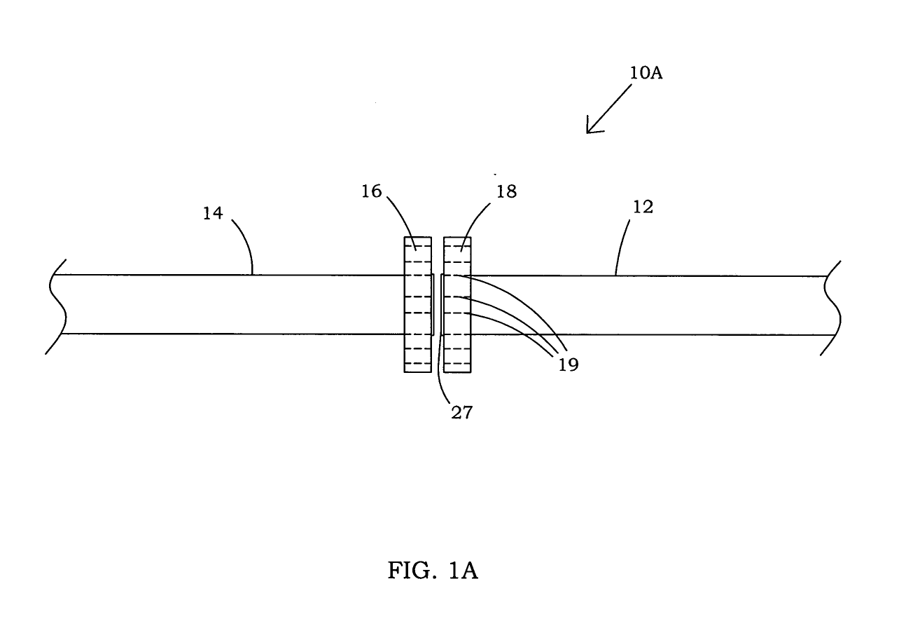

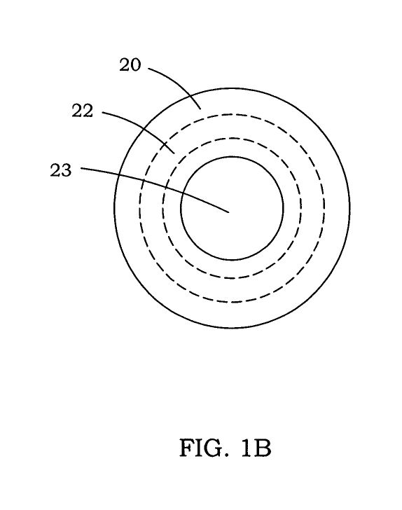

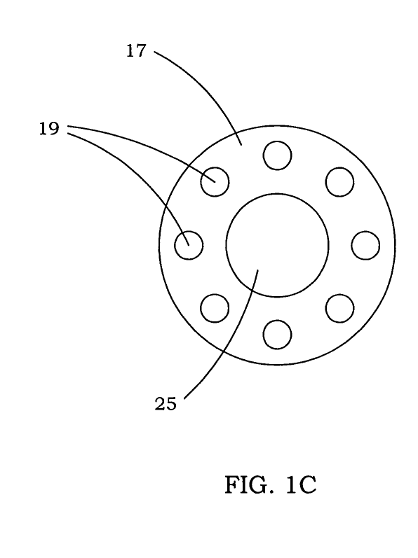

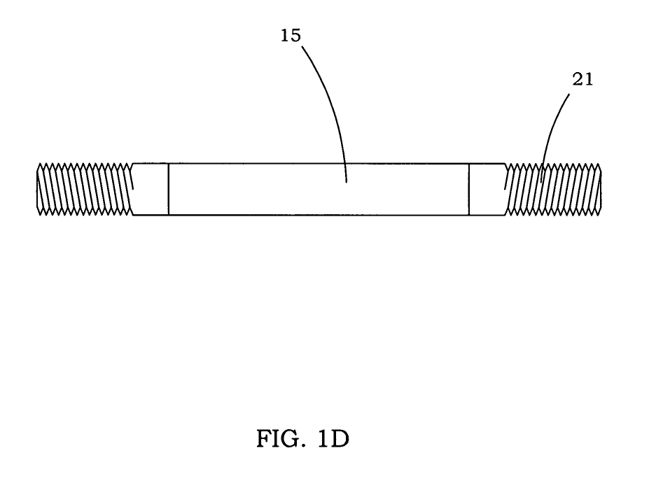

Turning to the drawings, and in particular FIG.1A, FIG. 1B, FIG. 1C, and FIG. 1D, there are shown various components, which may be utilized in one possible embodiment of corrosion mitigation system 10A for pressurized metal pipes 12 and 14. For pressure containment purposes, pipes 12 and 14 are connected utilizing flanges 16 and 18, which may be welded to pipes 12 and 14. However, in FIG. 1A, the flanges are not yet connected together. The pipes and/or flanges may vary greatly in size. For example, flanges may range from below four inches to fifty or more inches in diameter. The pipes may also vary in size according to use. The pipes and interconnections are generally pressure rated with smaller diameter pipes sometimes in the 10,000 psi range or higher. Larger diameter pipes will have lower pressure ratings. The pressure ratings may range from 500 psi to 10,000 psi but can also vary above and below this range. Pipes such as pipes 14 and 16 may be coated externally and/or internally with one or more coats of insulative material and/or acid or corrosive resistant materials, and the like, depending on use. Pipes 14 and 16 may have an internal and/or insulative cylindrical or pipe-like layer of material, if desired.

Flange 17 is shown in a front elevational view in FIG. 1C, which is representative for flanges 16 and 18. The flanges may comprise multiple openings, such as openings or bores 19, which surround through bore 25 through flange, in a circular pattern.

In one possible embodiment, insulated fasteners are used in bores 19, such as insulated metallic stud 15, shown in FIG. 1D, having threads 21. Insulated bolts, insulated nuts and/or washers, and the like, which may be utilized to secure the flanges together with significant torque applied thereto to control pressurized fluids such as liquids and gasses contained within the pipes. In one possible embodiment, insulated stud 15 may comprise a sleeve with insulation material such as Teflon or the like, with a tolerance of 0.1000 inches or less, if desired. If desired, studs or other fasteners comprised of insulative materials may be utilized but may require larger diameters than steel fasteners to provide the sufficient tightening force to maintain the pressurized ratings of the connectors.

Referring to FIG. 1B, Teflon gasket 20 with insert 22 may be cut or otherwise sized to fit to flange faces, such as flange face 27. Through bore 23 of gasket 20 mates with bore 25 through flange 17 to allow material flow through the pipe line. In one possible embodiment, insert 22 may be steel, steel mesh, or the like. However, other types of inserts such as composite material and/or other hard materials may also be utilized. Other types of insulation materials besides Teflon® may also be utilized.

Teflon coated gaskets with steel inserts, which may be utilized in some embodiments of the invention, are commercially available for use with flanged connections for pipelines, under the name of Texalon™ gaskets. However, in another embodiment, other materials may be utilized for the soft sealing material such as rubber, rubber-like, elastomeric, and/or flexible sealing material. Other reinforcement materials, which may or may not utilize steel inserts within the gaskets, and/or other hard materials, carbon materials, composite materials, and/or the like may be utilized so long as they are suitable for the pressure rating of the flange connection.

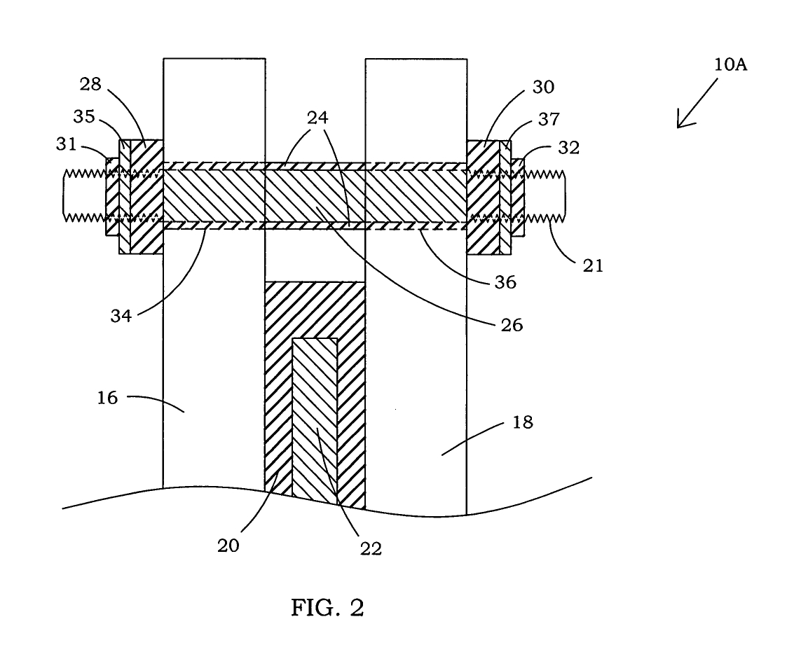

Referring to FIG. 2, there is shown an enlarged view, which shows details of one possible fastening arrangement for corrosion mitigation system 10. In a possible embodiment, first flange 16 and second flange 18 are secured together by use of insulated sleeve 24, metallic stud 26, insulated washers 28 and 30, back up metallic washers 35 and 37, and metallic nuts 31 and 32. Alternative insulated fastening means could be utilized such as insulated metallic bolts, non-metallic composite materials, or the like, when available which are suitably strong to secure the flange connection in a manner which maintains the seal at the desired pressure rating.

In one embodiment, insulated sleeve 24 is a pliable insulative material, such as Teflon® or other relatively soft or shrinkable material, which may be fitted, heat shrinked, or otherwise secured to otherwise metallic stud 26. In another embodiment, insulated sleeve 24 could be a rigid material, such as Delrin®, inserted into first aperture 34 of first flange 16 and second aperture 36 of second flange 18. In another embodiment, multiple layers of soft and/or hard insulative materials may be utilized as insulated sleeve. Alternatively insulative 24 sleeve may be baked on, sprayed on, or coated to stud 26 and/or may also comprise layers of insulative material and/or insulative coatings and/or layers of soft and/or hard insulative materials.

In one possible embodiment, flanges 16 and 18 may comprise one or more insulative coatings which is engaged by a pliable surface of insulative sleeve 24. In another embodiment, insulative sleeve may comprise a hard insulative material and a softer pliable component which may engage the insulative coatings of internal surfaces of first aperture 34. In another embodiment, various insulative layers of pliable and/or hard materials may be utilized. Soft insulative layers or other soft or pliable coatings may be provided on insulative sleeve 24 to engage insulative coating within the internal surfaces of aperture 34.

As noted above, first flange 16 and second flange 18 may typically, but not necessarily, comprise a plurality of circular apertures 34 concentrically located around the flanges, such as bores 19, shown in FIG. 1C. In one possible embodiment, insulated gasket 20 engages first flange 16 and second flange 18 and is circularly sized but with a radius smaller than circular apertures locations on the flanges so as to remain within the circle formed by the plurality of apertures. However, insulated gasket 20 may also comprise openings which mate to the aperture 34, and/or mate to bores 19, shown in FIG. 1C.

As discussed in some possible embodiments hereinbefore, insulated sleeve 24 is designed for snug fit around bolt 26 which is inserted through insulated sleeve 24. Bolt 26 may be coated with insulative material prior to use of sleeve 24. In this embodiment, insulated bolt or stud 26 has threads 21 on both ends which extend outwardly from first flange 16 and second flange 18 once properly inserted into insulated sleeve 24. Insulated sleeve 24 may be fitted and cut to the size and length of flanges being used and may typically have tight clearance around metallic bolt or stud 26.

Insulated washer 28 engages with first flange 16, and is secured by metal washer 35 and nut 31, which is tightened sufficiently to provide the sealed pressure rating of the pipe. Insulated washer material 28 may comprise one or more internal supports, such as steel or composite materials, if desired, separated by one or more insulative layers. If the flange is coated with insulative material, then insulated washer 28 may comprise a pliable surface component to engage the coating of the flange. Insulated washer 28 may comprise various layers and/or comprise multiple layers and/or coatings of pliable and/or hard insulative material. Insulated material should be of a thickness and radial size to place sufficient pressure on flange 16 to provide the pressure rating.

Accordingly, insulated washer 28 does not have to have the strength of steel but instead may comprise a larger radial size than is normally required when only metal washers/nuts are utilized to thereby, along with metal washer 35, place sufficient force for the desired pressure rating on flanges 16 and 18 and flange gasket 20. In other words, by utilizing an insulative material with a compression strength less than steel but with a larger radial size, sufficient pressure or force may be applied to flanges 16 and 18. In another embodiment, other washer arrangements may be utilized. A similar arrangement of washers and nuts may utilize insulated washer 30, metal washer 37, and nut 32 to tighten second flange 18 with first flange 16 to the desired tightness required for the pressure rating of the pipe. This connection point can then withstand the pressurized fluids and/or gas that will often be transported by the pipeline.

As depicted in FIG. 2, there is no metal to metal contact between first flange 16 and second flange 18, which along with the pipes themselves is an area where galvanic corrosion is common in pipeline configurations. The use of insulated sleeve 24, insulated washers 28 and 30, and insulated gasket 20, prevents electrical connections between the pipes and thereby can mitigate corrosion not only at the flanges but also including corrosion that may occur within the pipes.

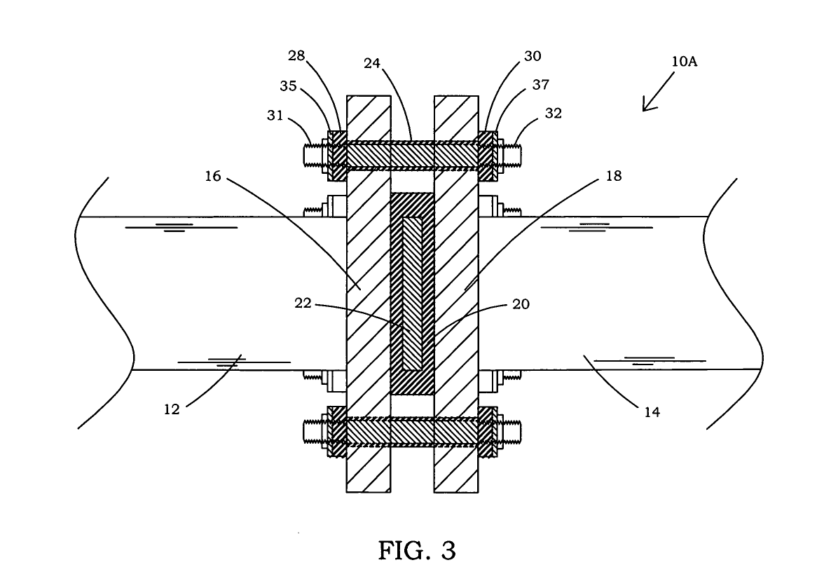

FIG. 3 illustrates an elevational side view, partially in cross-section, of one possible embodiment of corrosion mitigation system 10A, which shows a completed flange connection between the pipes. As discussed hereinbefore, a pipeline will consist of a plurality of metal pipes, such as metal pipe 12 and metal pipe 14. As noted hereinbefore, the metal pipes may comprise other components or layers, such as interior tubular coatings and layers, which may or may not comprise metal. As discussed above, first flange 16 of metal pipe 12 is insulated from second flange 18 of adjacent metal pipe 14 by insulated gasket 20 which is preferably round or disc shaped with a center aperture therethrough approximately equal to the size of an open end of metal pipes 12 and 14. Insulated gasket 20 is positioned between first flange 16 and second flange 18 to prevent any metal to metal contact between the metal pipes 12 and 14, while not obstructing the free flow of fluids transported within the pipeline. Insulated gasket 20 can be used for metal pipe flanges ranging from 3″ to 50″.

As discussed above, insulated gasket 20 comprises insulative material and may, in one possible embodiment, comprise metal core 22 or other types of support material and/or may comprise insulative composite materials. In one possible embodiment, metal core 22 may comprise any of the following, including: perforated stainless steel, nickel iron chromium alloy, titanium, gold, platinum, graphite, or carbon. By utilizing insulated gasket 20, electrolysis prevention system 10 provides a tight seal with structural support, without sacrificing the goal of electrolysis mitigation.

First flange 16 and second flange 18 are secured together by use of insulated sleeve 24, bolt 26, insulated washers 28 and 30, and/or other metallic or non-metallic washers, and nuts 31 and 32. This configuration allow for securing pipeline sections 12 and 14 without compromising electrolysis prevention where first flange 16 of metal pipe 12 and second flange 18 of metal pipe 14 connect. Electrolysis prevention system 10 is capable of electrically insulating a plurality of metal pipes from each other with a resistance greater than 100 kiloohms in free space, or in another embodiment greater than 1 megaohm in free dry space, and in another embodiment greater than 10 megaohms in free dry space. It will be appreciated that various insulative coatings and the like may typically be utilized on the exterior of the flange connections, which cover any spaces or air gaps, to further protect the flange connections and/or pipes from the elements. Coatings may be applied prior to and/or after assembly. Other coatings and/or materials may be utilized on the pipes. As discussed hereinbefore, coatings may be utilized within the apertures, on the surface of the bores, through which the fasteners are inserted. Sleeves 24 may be soft, hard, or multilayered with an outer relatively soft or pliable layer, such as Teflon®, for preventing damage thereto.

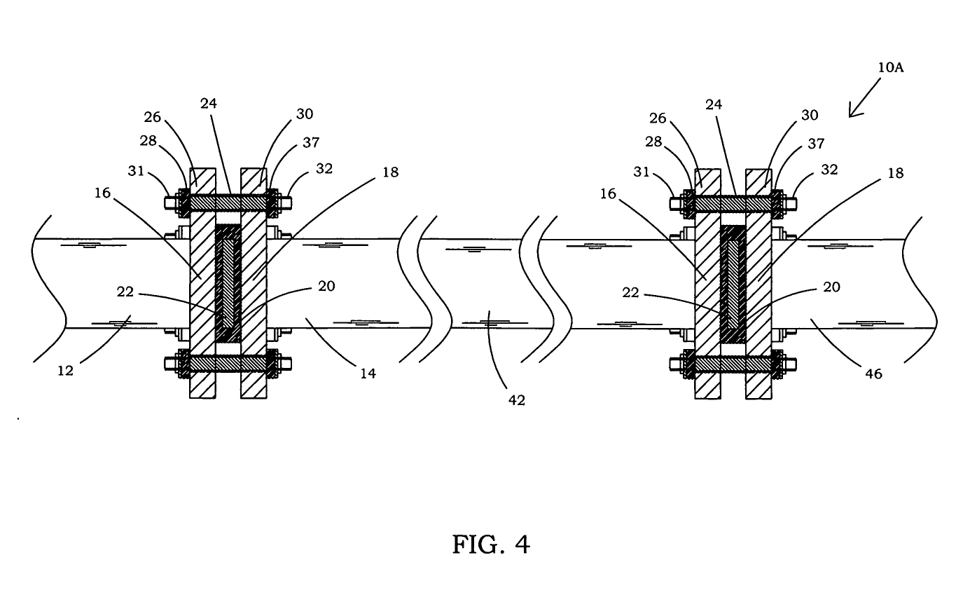

Turning to FIG. 4, there is shown another view of electrolysis/corrosion mitigation system 10A, depicting how the system prevents electrolysis in multiple sections of pipeline. The drawing shows metal pipes 12, 14, 42, 46, and/or any number of pipes. In one embodiment, each pipe is insulated from all other pipes by the insulated flange connection discussed hereinbefore.

In accord with methods of the present invention, during installation first flange 16 of metal pipe 12 is insulated from second flange 18 of adjacent metal pipe 14 by insulated gasket 20. Insulated gasket 20 is positioned between first flange 16 and second flange 18 to prevent any metal to metal contact between the metal pipes 12 and 14. In this embodiment, first flange 16 and second flange 18 are secured together by use of insulated sleeve 24, bolt 26, insulated washers 28 and 30, additional washers, and/or nut 31 and 32, as discussed hereinbefore. The process is repeated for metal pipe 14 and metal pipe 42. As explained hereinbefore, bolt 26 is insulated utilizing and/or inserted through one or more insulated sleeves 24 which is secured on one end to first flange 16 of metal pipe 14 by insulated washer 28 and nut 31. Insulated washer 30 and nut 32 secure bolt 26 on the opposite end to second flange 18 of metal pipe 15. To be noted, by isolating the individual metal pipes, particularly where first flange 16 and second flange 18 connect to each other, the present invention prevents electrolysis and/or galvanic corrosion.

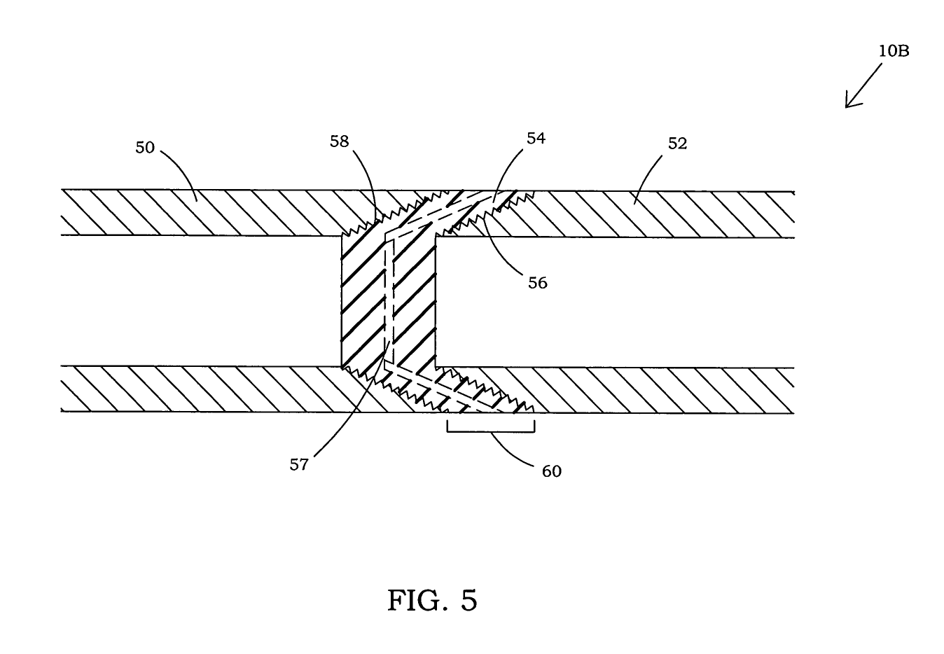

FIG. 5 represents an alternative embodiment of electrolysis prevention system 10, the present embodiment being configured for interlocking pipelines. Metal pipe 50 has a female threaded end 58 while metal pipe 52 has male threaded member 56. Insulated threaded gasket 54 is comprised of a non-conductive composite material in this embodiment, though other materials are readily available provided the provide sufficient electrical insulation, as discussed hereinbefore. Such materials may comprise composite materials or any other suitable insulative materials and/or the like. Furthermore, insulated gasket 54 may contain metal or composite material supports or core 57 to provide additional structural support for connection 60, if desired. Such pipes may be utilized in various suitable environments including pipe lines, as production tubing in oil wells and/or the like. Insulated gasket 54 comprises mating threaded connectors and mates with male threaded member 56 and female threaded member 58 to form connection 60 and may also comprise coatings, lubricants, and the like. Connection 60 should be sufficient to withstand the force from the pressurized fluids and/or gases present within the pipeline. As discussed hereinbefore, insulated gasket 54 both connects and electrically isolates pipeline section 50 and pipeline section 52 simultaneously. As a result, the interconnected sections of pipeline can withstand the pressurized fluids and/or gases, while mitigating the chance of electrolysis by avoiding metal to metal contact Electrolysis prevention system 10 is capable of electrically insulating a plurality of metal pipes from each other with a resistance greater than 100 kilo Ohms in dry space, or in another embodiment greater than 1 Mega ohm if free dry space, and in another embodiment greater than 10 mega ohms in free dry space.

In summary, the present invention may be utilized to isolate sections of pipeline to prevent corrosion related to electrolysis. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A corrosion mitigation system for use in a pressurized pipeline for carrying pressurized fluids, comprising:
a plurality of metal pipes wherein each of said plurality of metal pipes comprises connectors on opposite ends which when connected together form said pressurized pipeline, said connectors comprising metallic connector components;
insulative material components which conform to said metallic connector components at said connections between said plurality of metal pipes, said insulative material components being operable to provide electrical insulation between adjacent of said plurality of metal pipes with respect to each other greater than 100 kiloohms in dry space, said insulative material conforming to respective ends of said plurality of metal pipes while being sized to permit sufficient connection force at said connections to prevent leakage of said pressurized fluids when said pressurized fluids are at a pressure of 500 psi or greater.

2. The system of claim 1 wherein said connections further comprise a plurality of metal flanges for said plurality of metal pipes, wherein said insulative material comprises a plurality of metal fasteners which are insertable into said plurality of metal flanges, plurality of insulated gaskets which fit between said plurality of metal flanges, a plurality of insulated fastener sleeves surrounding said plurality of metal fasteners, and a plurality of insulated fastener washers, which are positioned around said plurality of metal fasteners and engage said plurality of metal flanges.

3. The system of claim 2, wherein said plurality of metal flanges are coated with an insulative material coating and said insulated washers comprise a pliable surface to engage said insulative coating material.

4. The system of claim 1, wherein said connections further comprise a plurality of threaded metal members, wherein said insulative material comprises at least two insulated material threaded connectors which mate to said plurality of threaded metal members between said adjacent of said plurality of metal pipes, whereby said plurality of metal pipes are electrically insulated from each other with respect to said connections of said plurality of metal pipes.

5. The system of claim 4, wherein said at least two insulated material threaded connectors comprise a male threaded connector and a female threaded connector.

6. A corrosion mitigation system for use in a pressurized pipeline for carrying pressurized fluids, comprising:
a plurality of metal pipes which form said pressurized pipeline, said plurality of metal pipes each comprising a first flange on one end and a second flange on an opposite end, said first flange and said second flange each comprising a plurality of circularly oriented and mating apertures;
a plurality of insulated gaskets, said plurality of insulated gaskets comprising insulative material and being positioned to engagingly seal and electrically insulate said first flange and said second flange of said plurality of metal pipes with respect to said first flange and second flange of adjacent of said plurality of pipes;
a plurality of metal fasteners which extend through said plurality of circular mating apertures to secure said first flange and said second flange of said plurality of metal pipes together with sufficient connection force at said connections to prevent leakage of said pressurized fluids;
a plurality of insulated sleeves for said plurality of metal fasteners, which insulate said plurality of fasteners from said first flange and said second flange of said plurality of metal pipes; and
a plurality of insulated washers for said plurality of metal fasteners, which insulate said plurality of fasteners from said first flange and said second flange of said plurality of metal pipes.

7. The system of claim 6 wherein plurality of flanges comprise a coating of insulative material and said plurality of insulated washers comprise a pliable material for contacting said coating of insulative material.

8. The system of claim 7 wherein plurality of flanges comprise a coating of insulative material and said plurality of insulated sleeves comprise a pliable material for contacting said coating of insulative material.

9. The system of claim 7 wherein said plurality of insulated gaskets are sized to engage a raised face on at least one of said first flange and said second flange.

10. The system of claim 6 wherein said plurality of insulated washers for said plurality of metal fasteners are disc shaped and sized to provide said sufficient connection force at said connections to prevent leakage of said pressurized fluids.

11. The system of claim 6 wherein said insulated gaskets, insulated washers, and insulated sleeves insulate said sections of pipeline from each other with a resistance greater than 100 kilo ohms in dry space.

12. A process for mitigating corrosion for use in a pressurized pipeline for carrying pressurized fluids comprising the steps of:
providing a plurality of metal pipes, said plurality of metal pipes containing a first flange on one end and a second flange on an opposite end of said pipes, said first flange and said second flange each having a plurality of circularly oriented apertures;
providing a plurality of insulated gaskets, to engage, seal, and electrically insulate said first flange and said second flange between adjacent of said plurality of metal pipes;
providing a plurality of insulated metal fasteners which secure said first flange and said second flange of said plurality of metal pipes together;
providing a plurality of insulated washers for said plurality of fasteners.

13. The process of claim 12 further comprising the step of providing that said plurality of insulated gaskets are disc shaped, have a center aperture therethrough, and comprise a support element therein.

14. The process of claim 13 further comprising providing an insulative coating for first flange and said second flange and providing that said insulated washers comprise pliable material for engaging said insulated coating.

15. The process of claim 12 further comprising providing an insulative coating for first flange and said second flange and providing that said insulated metal fasteners comprise pliable material for engaging said insulated coating.

16. The process of claim 12 further comprising that said plurality of insulated washers comprise a diameter sufficient to provide said sufficient connection force at said connections to prevent leakage of said pressurized fluids at pressures of at least 500 psi.

17. The process of claim 12 further comprising the step of providing that said insulated gaskets, insulated washers, and insulated sleeves insulate said plurality of pipes from each other with a resistance greater than 100 kilo ohm in dry space.
